(19) United States
(12) Patent Application Publication
(10) Pub. No.: US 2026/0100731 A1
(43) Pub. Date: Apr. 9, 2026

(54) SHARED REVERSE POWER FEED DIGITAL COMMUNICATION DEVICES

(71) Applicants: Justin L. Synstelien, Chanhassen, MN (US); Alec R. Synstelien, Chanhassen, MN (US); Brady M. Synstelien, Chanhassen, MN (US); Garrett D. Synstelien, Chanhassen, MN (US); Larry D. Synstelien, Chanhassen, MN (US)

(72) Inventors: Justin L. Synstelien, Chanhassen, MN (US); Alec R. Synstelien, Chanhassen, MN (US); Brady M. Synstelien, Chanhassen, MN (US); Garrett D. Synstelien, Chanhassen, MN (US); Larry D. Synstelien, Chanhassen, MN (US)

(21) Appl. No.: 19/349,266

(22) Filed: Oct. 3, 2025

Related U.S. Application Data
(60) Provisional application No. 63/703,323, filed on Oct. 4, 2024.

(51) Int. Cl. H04B 3/54; H04L 12/28

(52) U.S. Cl. CPC H04B 3/54; H04L 12/2801

(57) ABSTRACT

A plurality of digital communication ports, such as a plurality of modems, for communications with a distribution point unit (DPU) over multiple conductors, the modems including communication electronics for communicating radio frequency modulation (RF) communications over the multiple conductors and power electronics configured to programmably provide power to the DPU over at least some of the multiple conductors. The modems further including machine executable instructions for providing shared reverse power feed for the DPU. A variety of computing approaches may be used to generate the instructions for shared reverse powering of the DPU and other components of the system.

### CROSS-REFERENCE TO RELATED APPLICATION

This patent application claims the benefit of U.S. Provisional Ser. No. 63/703,323 , filed Oct. 4, 2024, which is incorporated by reference herein in its entirety.

### BACKGROUND

Subscribers of digital communications at a residence or business (the “service location”) have a number of options based on the connection options available at the service location. Traditional communications employ cable, fiber, wireless, and plain-old-telephone connection options. Each subscriber service provider has challenges deploying service to new subscribers and existing subscribers who request new service.

Cable and fiber networks require a cable and/or fiber drop at the service location to establish a digital connection. Conventional digital cable or optical fiber systems provide relatively fast communications but typically require a large capital investment associated with installing and maintaining cable and fiber networks and provisioning services to users. However, each service typically involves substantial installation and programming to ensure the subscriber has a proper connection.

Digital service providers may deploy special units at a home, apartment, or office configured to allow for digital communications to a plurality of subscribers at the home or office. One such device is a distribution point unit (DPU), which includes a multiport switch that connects to a plurality of modems. Such units can support various amounts of connections, such as (but not limited to) 2, 4, 8, 12, and 24 connections, etc. Some deployments may use multiple DPUs per building (e.g., for apartment complexes, condominiums, office malls, etc.). However, the DPUs require power for controlling the digital connections supported by the DPU. Such power connections may not be readily available, depending on the deployment of the DPU(s) at a location. Such power connections may also be unreliable depending on the deployment locations and conditions, resulting in intermittent loss of power to the DPU(s).

There is a need in the art for a system for easily and quickly deploying high speed digital communications to users at residential and commercial locations that may or may not have direct access to an electrical outlet for powering the switching equipment. Such a system should be easy and efficient to set up and use for high speed digital communications even when power is not readily available or is intermittent, preferably minimizing or reducing the delays, difficulties, and costs associated with establishing and/or maintaining service. Such a system may also provide flexibility for powering devices in cases where the system configuration changes. Such a system may provide power supply redundancies to make a more robust digital system with fewer power outages.

### SUMMARY

The present subject matter relates to an apparatus and method for providing power to a DPU from multiple modems at a service location. The present system includes a reverse power feed process configured to provide power to the DPU(s) via multiple conductors for digital communications, such as radio frequency (RF) modulation communications, between the modems and the DPU(s). The present system also allows for robust reverse powering of the DPU(s) using a system for providing power from multiple modems that adapt to the configuration of the modems, addition of modems, loss of power of some of the modems of the system, or other configuration changes to the system.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present patent application.

FIG. 1 illustrates a communications environment in which the present subject matter may be practiced.

FIG. 2 is a block diagram of a distribution point unit (DPU) in communication with a plurality of modems using a splitter according to various embodiments of the present subject matter.

FIG. 3A is an exemplary digital communication port showing various connection options according to one embodiment of the present subject matter.

FIG. 3B is a table showing light emitting diode (LED) assignment for an exemplary digital communication port according to one embodiment of the present subject matter.

FIG. 4 is a block diagram showing an example of a digital communication port employing RF modulation according to various embodiments of the present subject matter.

FIGS. 5-6 illustrate an exemplary digital communication vault showing various connection options according to one embodiment of the present subject matter.

FIG. 7 illustrates a deployment of a digital communication vault and digital communication ports of the present subject matter according to one embodiment of the present subject matter.

FIG. 8 is a block diagram showing an example of a digital communication vault and digital communication ports employing RF modulation according to various embodiments of the present subject matter.

FIG. 9 is a block diagram showing an exemplary digital communication vault according to one embodiment of the present subject matter.

FIG. 10 shows one example of the present subject matter with non-cable connections instead of cable connections.

FIG. 11 illustrates a deployment of a digital communication vault and digital communication ports of the present subject matter according to one embodiment of the present subject matter.

FIG. 12 is a block diagram illustrating components of a machine, according to some example embodiments, able to read instructions from a machine-readable medium (e.g., a machine-readable storage medium) and perform any one or more of the methodologies discussed herein.

FIGS. 13-14 are examples of a methods for selecting shared reverse power distribution according to various embodiments of the present subject matter.

FIG. 15 shows one example of a modem power up sequence according to one embodiment of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present subject matter provides digital communication devices, including digital communication ports, digital communication multi-ports and digital communication vaults that provide high-speed internet deployment using multiple conductor connections, such as twisted wire (e.g., twisted pair or any number of twisted conductors) or coaxial cable connections, for digital radio frequency (RF) modulation communications over the multiple conductors, wherein at least some of the multiple conductors used in the RF modulation communications are used to provide a distributed reverse power source. Such systems supply power from each of a plurality of digital communication ports to a communication vault connected to the plurality of digital communication ports. In various embodiments the communication vault is a distribution point unit (DPU) connected to a plurality of modems.

The present subject matter provides an intelligent, shared reverse power sourcing that allows devices in the system that are powered to collectively source power to distribution devices in the system. In various embodiments the system enables multiple communication ports at a location, such as modems, to share the sourcing of power to one or more distribution point units needing power. The system enables a power relay function to distribute power to distribution point units and ports in need of it, whether in series or parallel. In various embodiments, power and data are relayed over the same electrical connection.

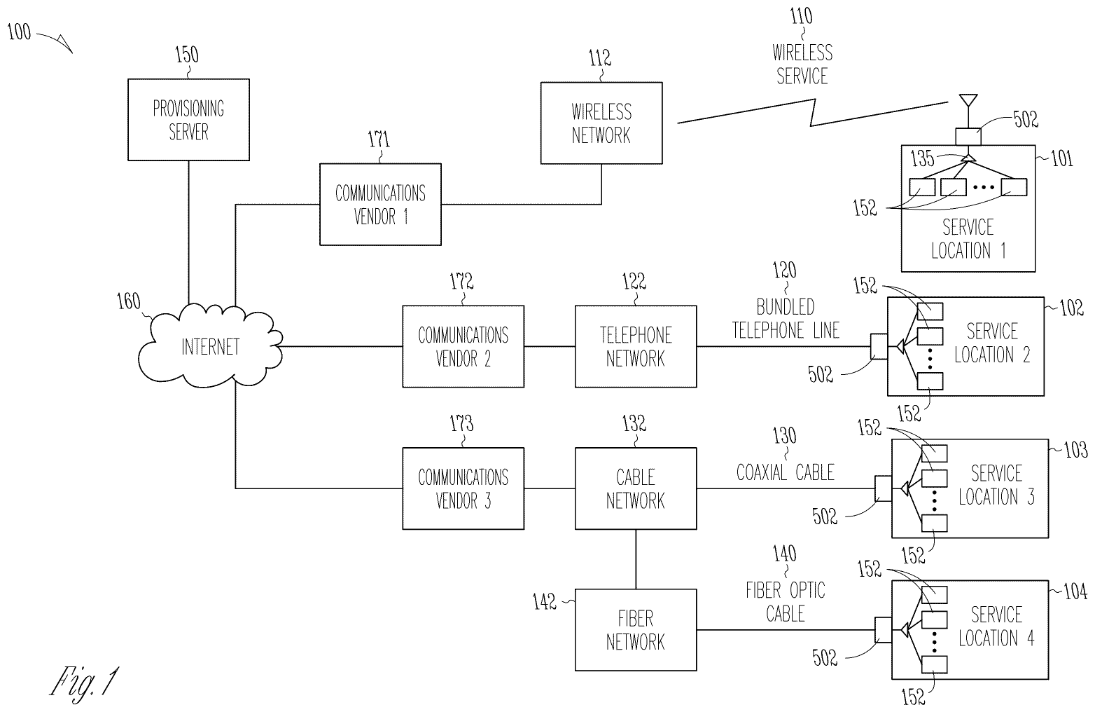

FIG. 1 illustrates a communications environment in which the present subject matter may be practiced. The communications environment 100 may include a number of service locations 101, 102, 103, and 104. A plurality of service locations may be used or deployed using the present subject matter. The service locations 101, 102, 103, and 104 represent examples of locations of subscribers of digital communications at a residence or business. The service locations 101, 102, 103, and 104 may have a number of options for digital communications based on the connection options available at the service location. Each location may include one or more communications options employing cable, fiber, wireless, and telephone connection options. In the exemplary embodiments, service location 101 has wireless service 110 for digital communications connected to a wireless network 112 to provide access to the internet 160. Service location 102 has bundled telephone lines 120 for digital communications connected to a telephone network 122 to provide access to the internet 160. Service location 103 has coaxial cable 130 for digital communications connected to a cable network 132 to provide access to the internet 160. Service location 104 has fiber optic cable 140 for digital communications connected to a cable network 132 via a fiber network 142 to provide access to the internet 160.

In various embodiments, one or more service locations 101, 102, 103, and 104 may include more than one option for connection to the internet 160. For example, a service location may include any combination of wireless service 110, telephone lines 120, coaxial cables 130 and fiber optic cables 140, and a user at such a service location may select the type of connection based on availability, cost, speed, preferred vendor, and/or personal preference. A number of communication vendors 171, 172, 173 (or subscribers service providers) may be available to enable access to the internet 160 from the one or more service locations 101, 102, 103, and 104. Each subscriber service provider has challenges deploying service to new subscribers and existing subscribers who request new service, and who may not have ready access to a power connection to provide power to the required equipment.

FIG. 1 also illustrates various deployments of a digital communications port 152 of the present subject matter according to various embodiments of the present subject matter. In various embodiments the digital communications ports 152 are connected to a splitter 135 which is in turn connected to a digital communication vault 502.

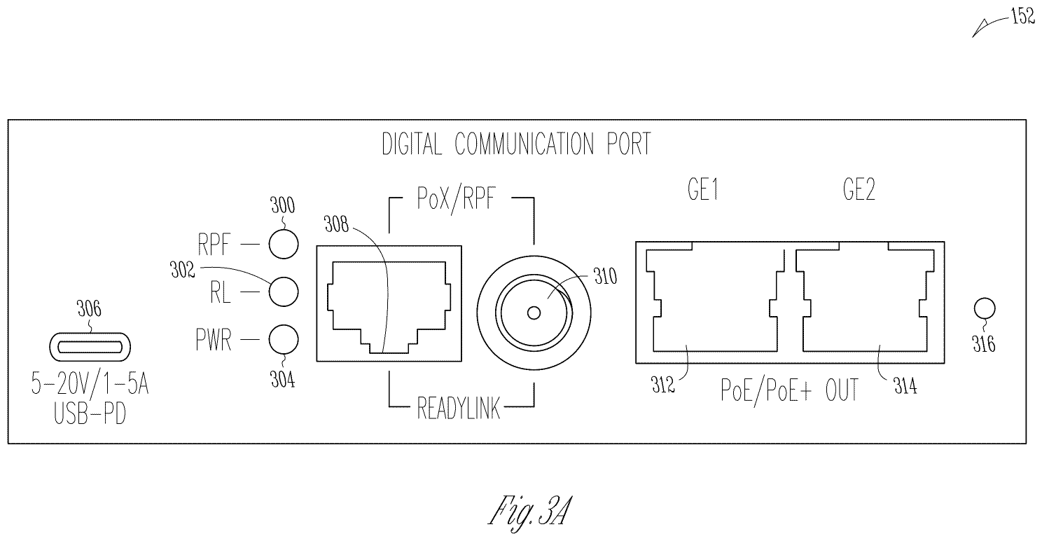

A user at a service location 101, 102, 103, and 104 may be provided with a digital communications port 152 of the present subject matter, such as the digital communications port 152 shown in FIG. 3A. The digital communications port 152 includes one or more inputs for connecting to available connection options at the service location. For example, the digital communications port 152 may include inputs compatible with wireless service 110, inputs compatible with bundled telephone lines 120, inputs compatible with coaxial cables 130, and/or inputs compatible with fiber optic cables 140. The user may connect the digital communications port 152 to one or more of the connections at a given service location, in various embodiments. When connecting the digital communications port 152, the user may access an application or software (such as the application and software discussed in co-pending, commonly assigned, U.S. Provisional Patent Application Ser. No. 63/203,140, entitled “FACILITATING AND PROVISIONING CUSTOMER BROADBAND TRANSPORT SERVICE”, filed on Jul. 9, 2021, U.S. Pat. No. 11,558,264, and U.S. Pat. No. 11,928,887, all of which are hereby incorporated by reference herein in their entirety) from a user's computer or personal device to interface with a provisioning server 150 over the internet 160. As will be shown in greater detail below, the provisioning server 150 interacts with the digital communications port 152 to provision the available connection resources at the service location 101, 102, 103, and 104 to provide an internet connection for the user.

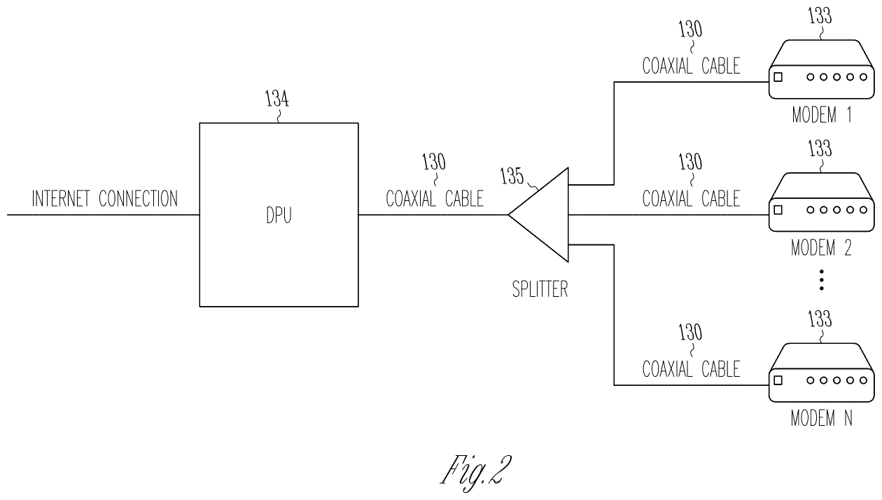

FIG. 2 is a block diagram of a distribution point unit (DPU) in communication with a plurality of modems using a splitter according to various embodiments of the present subject matter. The DPU 134 may be a digital communication vault 502, such as the one used to communicate with a cable network 132. The DPU 134 is in communication with the internet and is in communication with a plurality of modems 133 via splitter 135. The modems 133 are one example of digital communications ports 152.

FIG. 3A is an exemplary digital communication port 152 showing various connection options according to one embodiment of the present subject matter. The digital communications port 152 includes a number of input connections, output connections, buttons, and/or indicator lights. In various embodiments, the digital communications port 152 may include a different number of input connections, output connections, buttons, and/or indicator lights, without departing from the scope of the present subject matter. In the depicted embodiment, the digital communication port 152 includes a reverse power feed (RPF) status indicator light 300, communication status indicator lights 302, a power status indicator light 304, a universal service bus (USB-C) input 306, a twisted-pair telephone connector input/output 308, a coaxial cable connector input/output 310, a pair of ethernet cable connector input/outputs 312, 314, and a reset button 316. The reset button 316 is recessed, in various embodiments. According to various embodiments, one or more of the USB-C input 306, the twisted-pair telephone connector input/output 308, the coaxial cable connector input/output 310, or the pair of ethernet cable connector input/outputs 312, 314 may be used to provide power to and/or from the digital communications port 152. For example, in one embodiment twisted-pair telephone connector input/output 308 may be used as RPF connectors to receive power or to provide power to or from other devices, such as other digital communication ports 152. The RPF is enabled based on the input voltage of the USB-C input 306, in various embodiments. In another example, in one embodiment the pair of ethernet cable (RJ45) connector input/outputs 312, 314 may be used as power-over-ethernet (PoE) connectors to receive power or to provide power to or from other devices, such as other digital communication ports 152. The PoE power output on RJ45 ethernet ports can be switched on and off using software, in various embodiments.

These ports or modems may provide a signal to test the connection to another device, such as a vault or DPU or other digital device, at a relatively low voltage. The ports or modems determine if it is safe to supply power to devices, such as such as a vault or DPU or other digital device. The ports or modems are programmed with machine readable instructions that when executed perform the testing of the connection, establish a data link, and determine if it is safe to supply power to another device, such as a vault or DPU or other digital device.

In various embodiments, the present subject matter provides a digital communication port including communication electronics for communicating with at least one digital communications connector. In various embodiments, the digital communications port further includes a bidirectional power feed connection configured to receive power from or provide power to an external device via a two conductor connection configured for digital communications between the digital communication port and the external device. The digital communications include radio frequency (RF) modulation (or RF modulation communications), in various embodiments. In various embodiments, the RF modulation communications include one or more of discrete multi-tone (DMT) modulation (such as G.Fast or data modulation), orthogonal frequency division multiplexing (OFDM) (such as G.hn or multimedia over coax alliance (MoCA)), coded orthogonal frequency-division multiplexing (CODFDM), ultra-wideband (UWB) (such as ultra wideband, ultra-wide band and ultraband), pulse-position modulation, or orthogonal frequency-division multiple access (OFDMA). Other types of RF modulation communications can be used without departing from the scope of the present subject matter. The description below may use G.hn or G.Fast standard communications as examples, but it is understood that any type of RF modulation communications may be used with the present system.

FIG. 3B is a table 360 showing light emitting diode (LED) assignment for an exemplary digital communication port 152 according to one embodiment of the present subject matter. A power status indicator (such as 304 in FIG. 3A) is illuminated when power is supplied to the device. A link status indicator (such as 302) is green when the RF modulation communications signal (for example, the G.hn or G.Fast signal) has signal quality of greater than or equal to 50 Mbps, and is yellow when RF modulation communications signal has signal quality of less than or equal to 50 Mbps, and is off when no signal is detected. Other bit rates may be specified without departing from the present subject matter. A RPF power status indicator (such as 300) is on when the RPF port is enabled. A GE port status indicator (adjacent inputs/outputs 312, 314) has a yellow light when power is supplied from the PoE indicators and a green light that is solid when the port link is up and blinks when the link is up and active. Various colors of LEDs may be used without departing from the scope of the present subject matter.

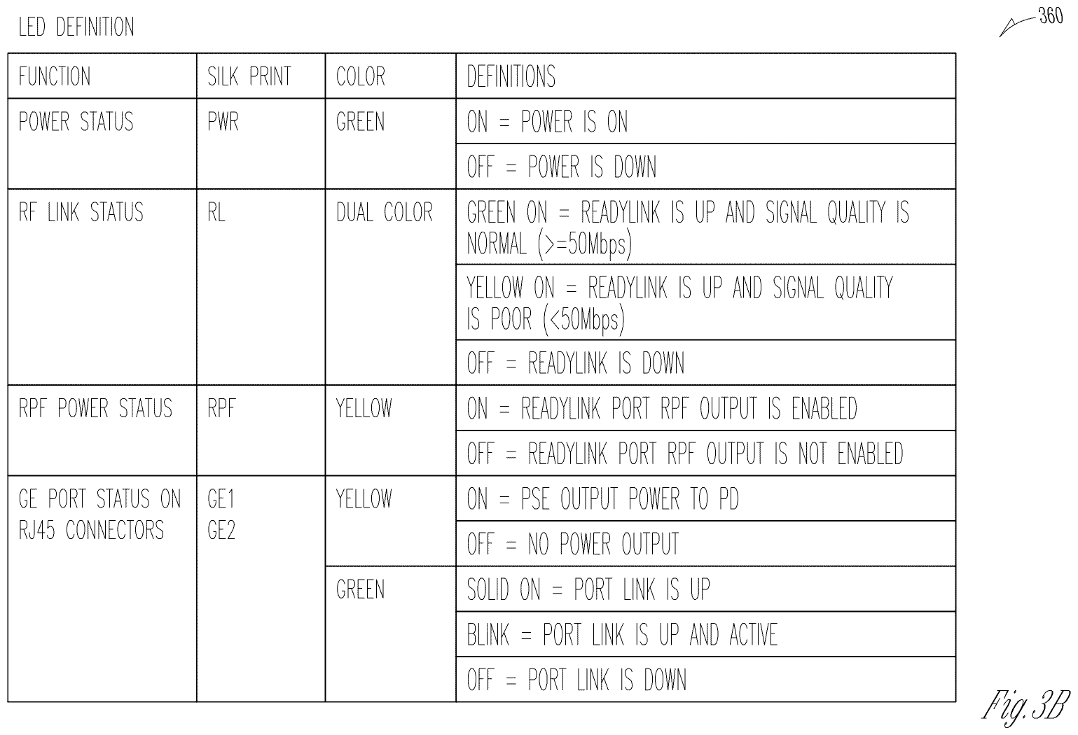

FIG. 4 is a block diagram showing an example of a digital communication port 152 employing an RF modulation communications according to various embodiments of the present subject matter. The digital communication port 152 includes an ethernet transceiver 404 configured to interface with a subscriber side 402 and a RF modulation transceiver 408 (for example, a G.hn or G.Fast transceiver 408) configured to interface with a telecommunications provider side 420, in various embodiments. In the depicted embodiment, the digital communication port 152 includes a processor or controller 406 programmed to control operation of the ethernet transceiver 404 and the transceiver 408, and further includes a power module 410 to provide electrical power to the ethernet transceiver 404, the transceiver 408, and the controller 406. In some embodiments, the port 152 receives power from a local power source input 424. In various embodiments of the present subject matter, the port receives or provides power from a bidirectional power feed input/output 422 (sometimes referred to herein as a reverse power feed (RPF)). The bidirectional power feed input/output uses the communication conductors (such as coaxial cable or twisted wire conductors) employed by the RF modulation communications(for example, G.hn, G.Fast, or other RF modulation standards communications). In various embodiments, RPF input/output can provide power or receive power, thus also referred to as a bidirectional power feed input/output. The ports and vaults of the present subject matter provide a reverse power feed, in various embodiments. The ports and vaults of the present subject matter provide a forward power feed, in various embodiments. The ports and vaults of the present subject matter provide a bidirectional power feed, in various embodiments. Thus, the devices of the present subject matter provide may provide a reverse power path, a forward power path, or a bidirectional power path, in various embodiments. In various embodiments, the devices of the present subject matter provide a power relay function.

The ports or modems are programmed with machine readable instructions that when executed perform the testing of the connection, establish a data link, and determine if it is safe to supply power to another device, such as a vault or DPU or other digital device. The executable instructions can be used by the port or modem to determine if it is connected to another device and to determine if it is safe to supply power to that device. In various embodiments, the power module or power module and controller can be used to execute instructions to determine whether to provide a shared reverse power feed (SRPF) to power another device, such as a vault or DPU. Other components may be used without departing from the scope of the present subject matter.

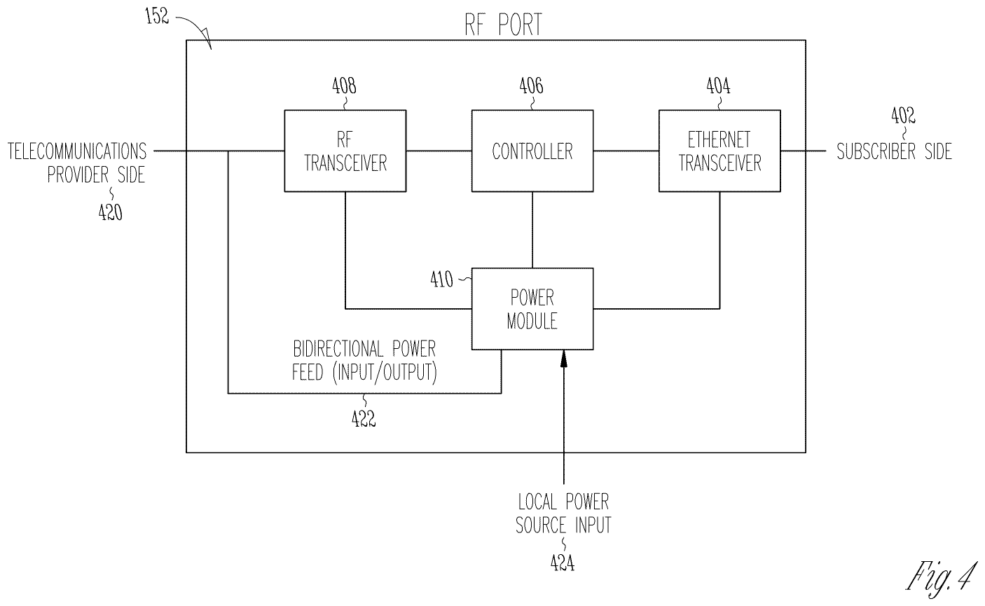

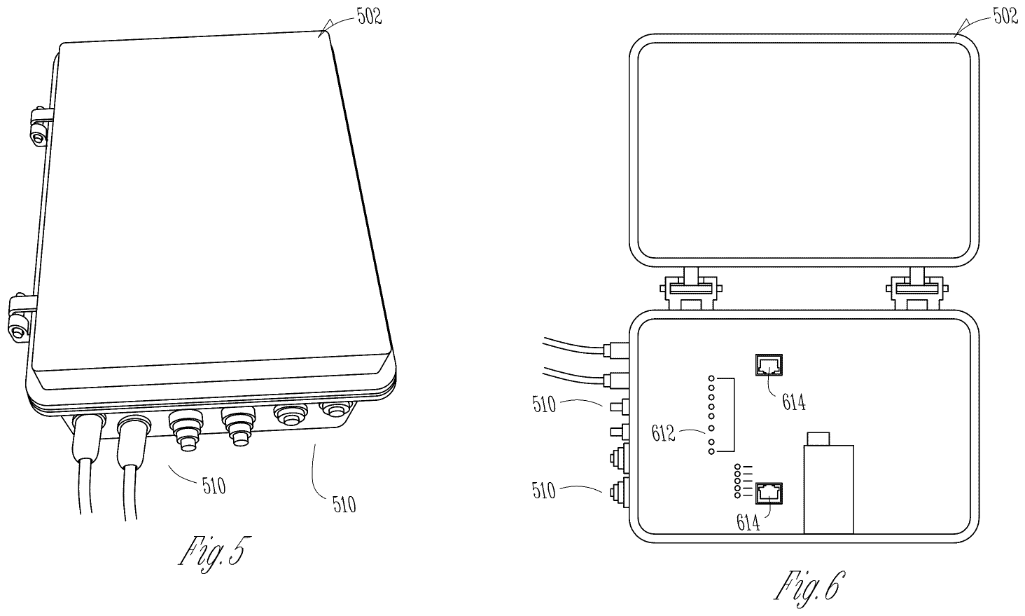

FIGS. 5-6 illustrate an exemplary digital communication vault 502 (such as a DPU) showing various connection options according to one embodiment of the present subject matter. The digital communication vault 502 includes a number of input connections, output connections, buttons, and/or indicator lights. In various embodiments, the digital communication vault 502 may include a different number of input connections, output connections, buttons, and/or indicator lights, without departing from the scope of the present subject matter. The digital communication vault 502 may be used on or near an exterior or interior of a building or service location, may be mounted with a wall, strand, or pole-mount bracket, and may interface with one or more digital communication ports 152 In the depicted embodiment, the digital communication vault 502 includes external connectors 510, internal connectors 614 within a housing having a weatherproof seal, and a plurality of status indicator lights 612. The housing may include a diecast aluminum allow, in various embodiments. The external connectors 510 may include one 2 or 4-core fiber jumper, one 20-pair copper pigtail, one 12V/3A type-C power outlet, and two F connectors for 50Hz synchronization signal input and output. The jumper and pigtail fit within a waterproof ⅝×24 cable gland, in an embodiment.

According to various embodiments, one or more of the external connectors 510 or the internal connectors 614 may be used to provide power to and/or from the digital communication vault 502. For example, in one embodiment a twisted-pair telephone connector input/output may be used as a reverse power feed (RPF) connector to receive power or to provide power to or from other devices, such as other digital communication vaults 502 or one or more digital communication ports 152. In various embodiments, each RF modulation communications port on the digital communication vault 502 acts as a power device (PD) complying with IEEE 802.3 at (power over Ethernet). In this example, the minimum power required is 15 Watts on the 12 Volt domain, when only one digital communication port is active. The power output depends on the power loss of the RPF system, including cable resistance and PD power efficiency, in various embodiments.

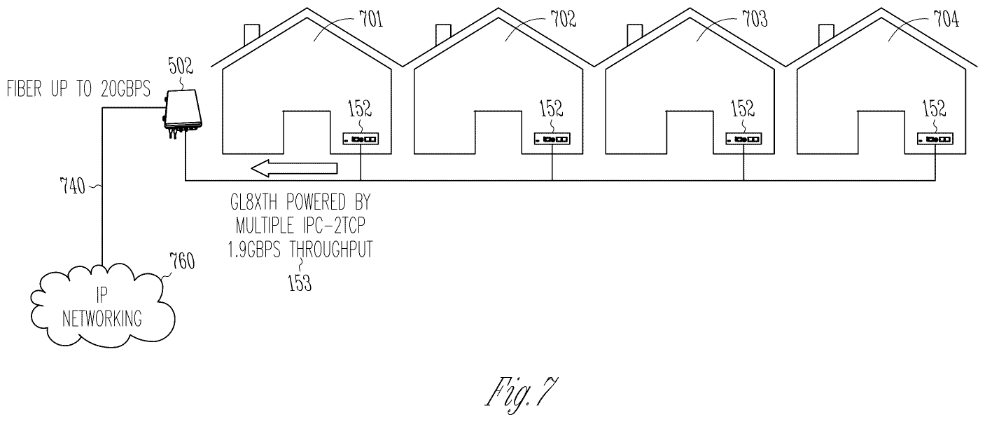

FIG. 7 illustrates a deployment of a digital communication vault 502 and digital communication ports 152 of the present subject matter according to one embodiment of the present subject matter. In the depicted embodiment, a plurality of service locations 701, 702, 703, and 704 each have a digital communication port 152 for internet service. The digital communication ports 152 are connected to a digital communication vault 502 that interfaces with a fiber optic cable 740 to provide internet via an internet protocol (IP) network 760. The digital communication vault 502 is connected to the digital communication ports 152 using communication conductors (such as twisted wire or coaxial conductors) employed by the RF modulation communications (for example, G.hn, G.Fast, and other RF modulation communications standards), in various embodiments. According to various embodiments, the digital communication vault 502 receives power via a reverse power feed (RPF) 153 using the communication conductors from one or more of the digital communication ports 152. In one embodiment, the digital communication vault 502 receives power via a reverse power feed (RPF) 153 using the communication conductors from all the connected digital communication ports 152.

According to various embodiments, the digital communication vault 502 (one example of a DPU) receives power via a shared reverse power feed (SRPF) 153 using the communication conductors from a plurality of digital communication ports 152. In various embodiments the digital communication ports 152 are modems which perform reverse power sharing to power the digital communication vault or DPU.

In various embodiments, the power provided by the modems to the DPU provides redundancy in powering the DPU to avoid loss of power to the DPU. For example, in the case where there are three (3) modems sharing power, the shared reverse power feed may be a fixed voltage, such as 54 volts, and the power provided to the DPU by each modem is approximately one-third (⅓) of the power needed to operate the DPU. The power provided may vary based on the ohmic loss of each connection from each modem.

Different voltages and currents may be used in various embodiments. For example, in Ethernet communications, voltages of between 40 and 56 volts may be used and voltages of about 48 volts are typical. Other standards and voltages and currents may be used without departing from the scope of the present subject matter.

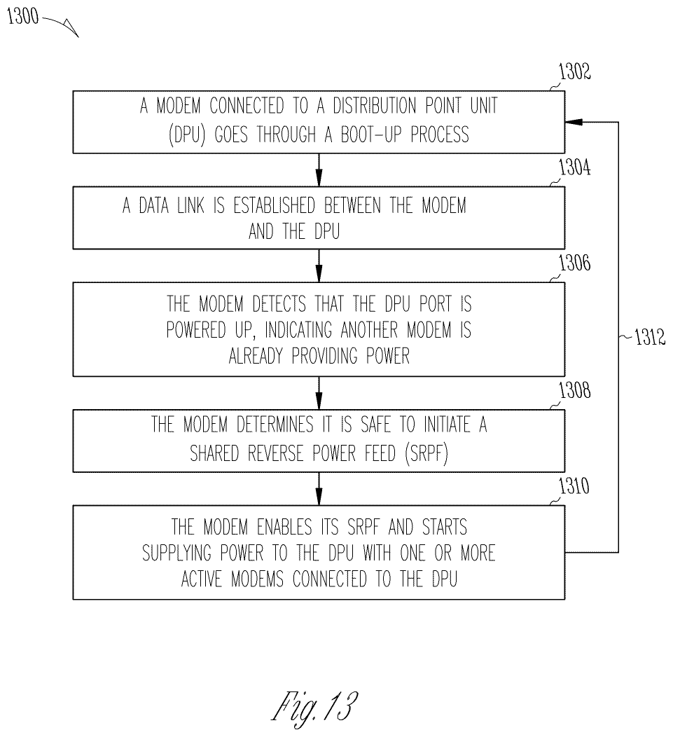

FIG. 13 shows a method for powering up the DPU using multiple modems, according to one embodiment of the present subject matter. The power sharing process 1300 is initiated after a modem connected to the DPU port goes through a boot-up process (1302), a data link is established between the modem and the DPU (1304), and the modem detects that the DPU port is powered up, indicating another modem is already providing power (1306). The modem determines it is safe to initiate a shared reverse power feed (SRPF) (1308). The modem enables its SRPF and starts supplying power to the DPU with one or more active modems connected to the DPU (1310). The process returns to the beginning (1312) and if another modem goes through a boot-up process the method is repeated (1302).

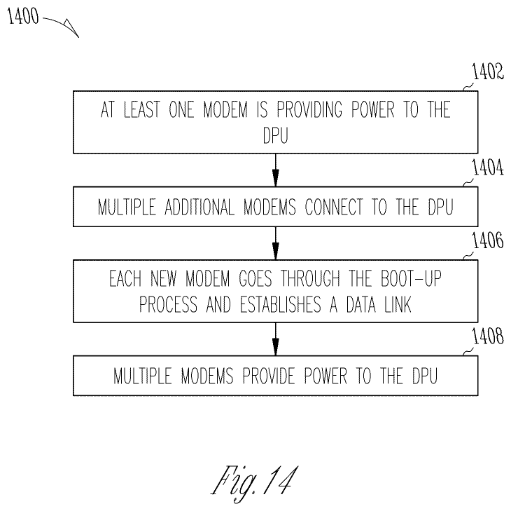

As shown in FIG. 14, once a reverse power session is being conducted by the system (1402), if an additional modem or modems connect to the DPU (1404), then each new modem goes through the boot-up process and establishes a data link (1406) and multiple modems supply power to the DPU (1408). If a modem is disconnected or loses power the remaining active modems continue to power the DPU, thereby adding redundancy to power the DPU and share the power supplied by each modem. According to some embodiments of the present subject matter, one or more modems may be selected to power the DPU. Other various embodiments may adjust or cycle power supplied by a plurality of active modems supplying (or able to supply) the DPU with power to operate the DPU. Other combinations of providing redundant power to the DPU using a plurality of modems may be employed without departing from the scope of the present subject matter.

In various embodiments, the method may involve a Power over Ethernet (PoE) handshake protocol to ensure safe power delivery. The modem sends a low-voltage pulse (around 5-7 volts) to detect connected devices. In various embodiments, devices may optionally communicate their power requirements and/or capabilities. Once the handshake is complete, the modem initiates full power delivery (48-56 volts). These methods allow the DPU to be powered in locations without readily available power sources, utilizing existing cable infrastructure for both data and power delivery, and allowing for redundant, shared sources of power for the DPU.

In various embodiments, the modem uses a relatively small voltage signal to detect whether the DPU will accept power and is connected for reverse power sharing. In various embodiments, the voltage is about 5 volts and is sufficient to conduct a digital communication session between the modem and the DPU. Other voltages may be employed to perform detection, including, but not limited to, about 6, 7, 8, or 9 volts.

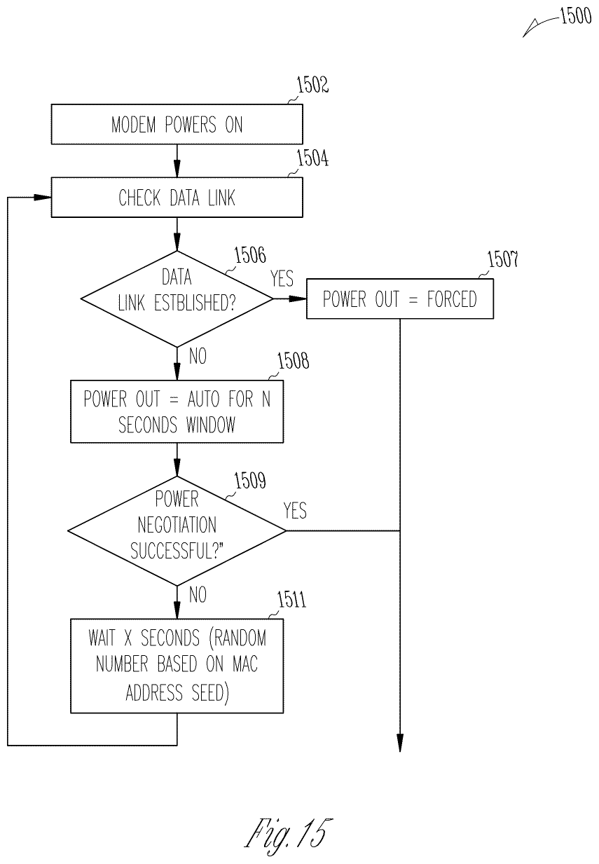

FIG. 15 shows one example of a modem power up sequence according to one embodiment of the present subject matter. The modem power up sequence (1500) includes powering up a modem (1502) and checking for a data link (1504). In one embodiment a G.hn link is checked. In one embodiment a G.Fast link is checked. Other standards may be employed without departing from the scope of the present subject matter. If the data link is confirmed, the power output of the modem is set to “forced” (1506). In such cases it is acceptable to force power because the data link implies that the modem has safely connected to another device, such as a vault or DPU. If the data link is not established, then for that modem the “power out” (which is a reverse power feed) is set to “auto” for an N second window (1508). Setting the “power out” to “auto” causes the modem to make another attempt to complete the handshake safely. If the power negotiation fails after the N second window, the modem is instructed to pause for X seconds (which, in certain embodiments, may be a random number based on the MAC address seed) (1510) and to test again for a data link (step 1504). Other power on procedures may be used without departing from the scope of the present subject matter.

In various embodiments the sharing of the power may be equal across modems or other digital communication ports. In various embodiments the sharing of the power may be a function of the power sourcing capabilities of each individual modem or data communication port. In various embodiments the sharing of the power may be adjusted based on ohmic line loads for different modems or other digital communication ports connected to the DPU. In various embodiments the sharing of the power may be cycled across modems or other digital communication ports. In various embodiments the sharing of the power may be re-adjusted across modems or other digital communication ports. In various embodiments, the reverse power sharing is allocated to the various active modems based on typical power demands of the DPU. In various embodiments, the reverse power sharing is allocated to the various active modems based on varying power demands. One such example relates to varying power demands of the DPU for additional powering functions performed by the DPU. For example, if the DPU is called to relay power to another device its immediate power requirement may increase to meet that relay power demand. In such cases one or more of the plurality of modems (or other data communication ports) may be activated to provide additional power to meet the increased power demands of the DPU. Other power sharing approaches are possible without departing from the scope of the present subject matter.

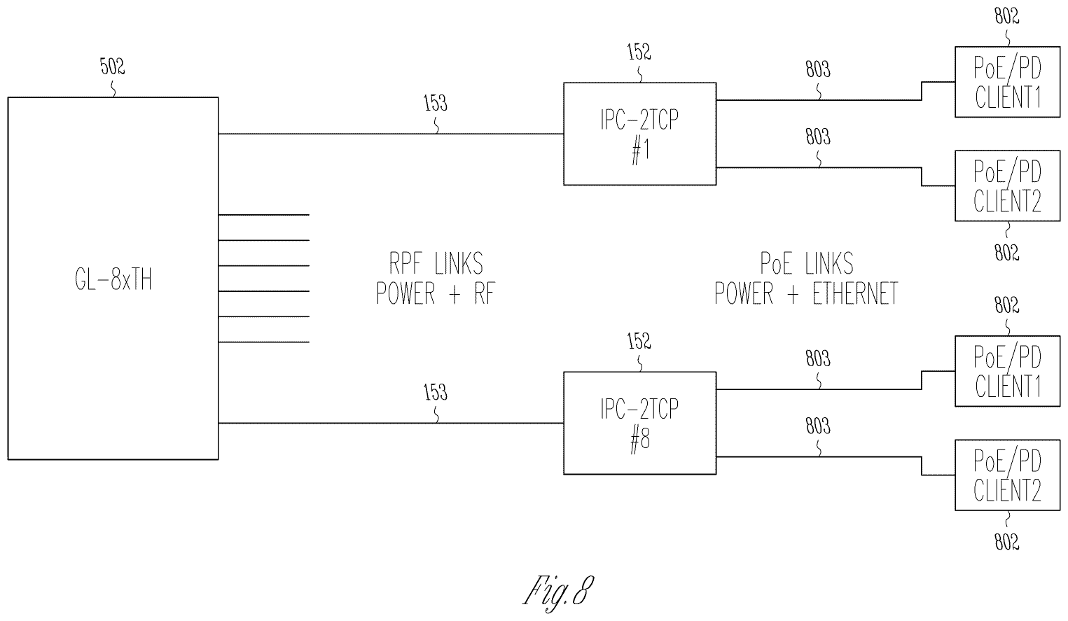

FIG. 8 is a block diagram showing an example of a digital communication vault 502 and digital communication ports 152 employing RF modulation communications according to various embodiments of the present subject matter. The digital communication ports 152 are connected to a digital communication vault 502 that interfaces with a network to provide internet via an internet protocol (IP) network 760. The digital communication vault 502 is connected to the digital communication ports 152 using the conductors that provide RF modulation communications, in various embodiments. According to various embodiments, the digital communication vault 502 receives power via a reverse power feed (RPF) or a shared reverse power feed (SRPF) 153 using the connections from one or more of the digital communication ports 152. In other embodiments, the digital communication vault 502 provides power via a reverse power feed (RPF) or a shared reverse power feed (SRPF) 153 using the connections to one or more of the connected digital communication ports 152. In the depicted embodiment, the digital communication ports 152 provide power to one or more client devices 802 using one or more power over ethernet (PoE) connections 803.

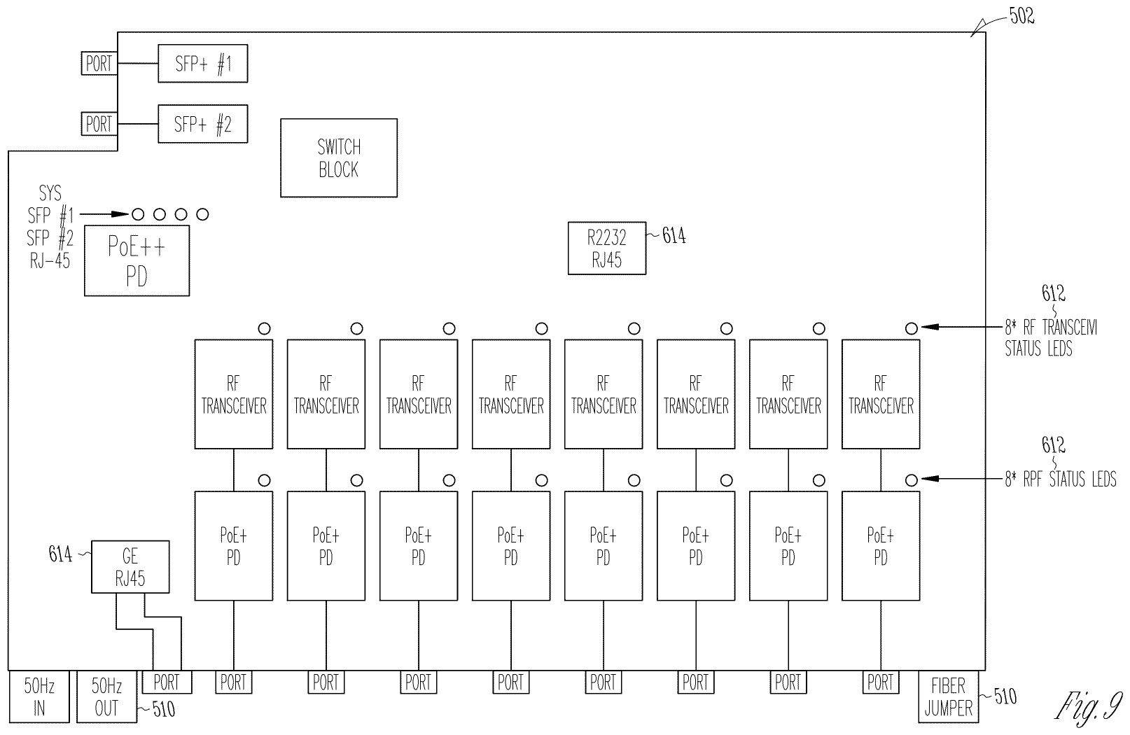

FIG. 9 is a block diagram showing an exemplary digital communication vault 502 according to one embodiment of the present subject matter. The digital communication vault 502 includes a number of input connections, output connections, buttons, and/or indicator lights. In various embodiments, the digital communication vault 502 may include a different number of input connections, output connections, buttons, and/or indicator lights, without departing from the scope of the present subject matter. The digital communication vault 502 may be used on or near an exterior to a building or service location and may interface with one or more digital communication ports 152 In the depicted embodiment, the digital communication vault 502 includes external connectors 510, internal connectors 614 within a housing having a weatherproof seal, and a plurality of status indicator lights 612. According to various embodiments, one or more of the external connectors 510 or the internal connectors 614 may be used to provide power to and/or from the digital communication vault 502. For example, in one embodiment a twisted-wire telephone connector input/output may be used as an RPF connector to receive power or to provide power to or from other devices, such as other digital communication vaults 502 or one or more digital communication ports 152. In various other examples, coaxial cable connections may be used.

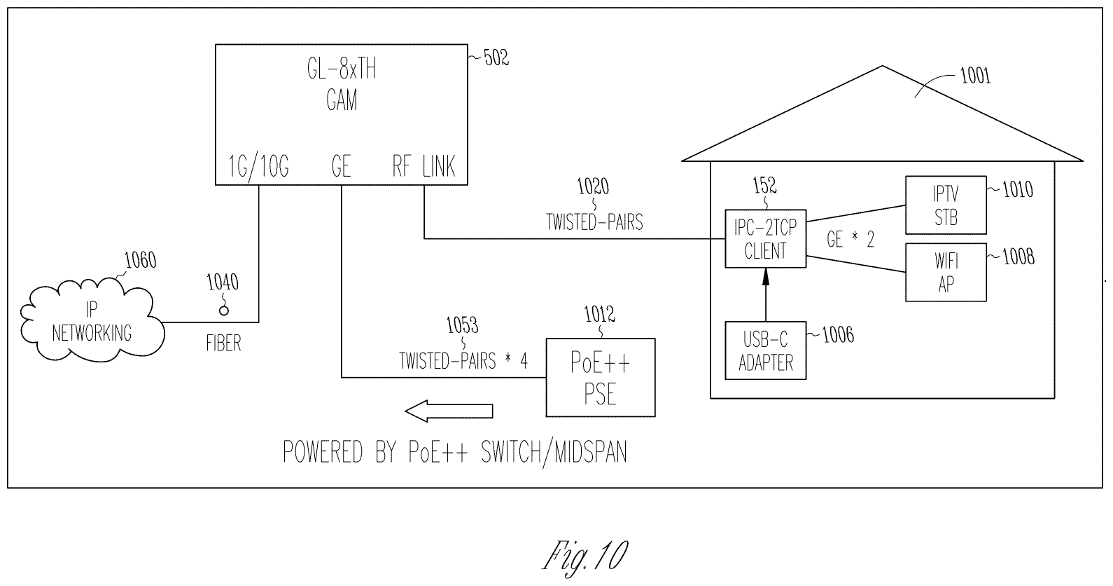

FIG. 10 illustrates various deployments of digital communication vaults and digital communication ports of the present subject matter according to various embodiments of the present subject matter. In FIG. 10, a service location 1001 has a digital communication port 152 for internet service. The digital communication port 152 is connected to a digital communication vault 502 that interfaces with a fiber optic cable 1040 to provide internet via an internet protocol (IP) network 1060. The digital communication vault 502 is connected to the digital communication port 152 using a twisted wire or coaxial connection 1020 to provide RF modulation communications, in various embodiments. The digital communication port 152 is powered via a USB-C adapter 1006 that supports 5 to 20 Volts and 1 to 5 Amps, and is connected to a wireless internet (Wi-Fi) access point 1008 and an internet protocol television set top box 1010 using ethernet connections, in an embodiment. In one embodiment, the digital communication vault 502 receives power via a power over ethernet (PoE) connection 1053 from one or more PoE supplying devices 1012. In various embodiments herein, PoE may refer to PoE, PoE+, or PoE++ protocols, without departing from the scope of the present subject matter.

In various embodiments, the digital communication vault 502 is connected to the digital communication port 152 using a twisted wire or coaxial connection 1020 to provide RF modulation communications. In various embodiments a digital communication vault 502 that interfaces with a fiber optic cable via a fiber optic daisy chain from other digital communication vaults 502 (that are not powered on) to provide internet via an internet protocol (IP) network. In various embodiments, the digital communication port 152 is connected to a digital communication vault 502 that interfaces with a fiber optic cable to provide internet via an internet protocol (IP) network. In various embodiments, the digital communication port 152 is connected to a digital communication vault 502 that interfaces with a fiber optic cable 1040 via a RF modulation converter (for example, a G.hn converter) to provide internet via an internet protocol (IP) network. These embodiments may employ the shared reverse power distribution approach of the present subject matter. Other configurations with different numbers of ports may be employed without departing from the scope of the present subject matter.

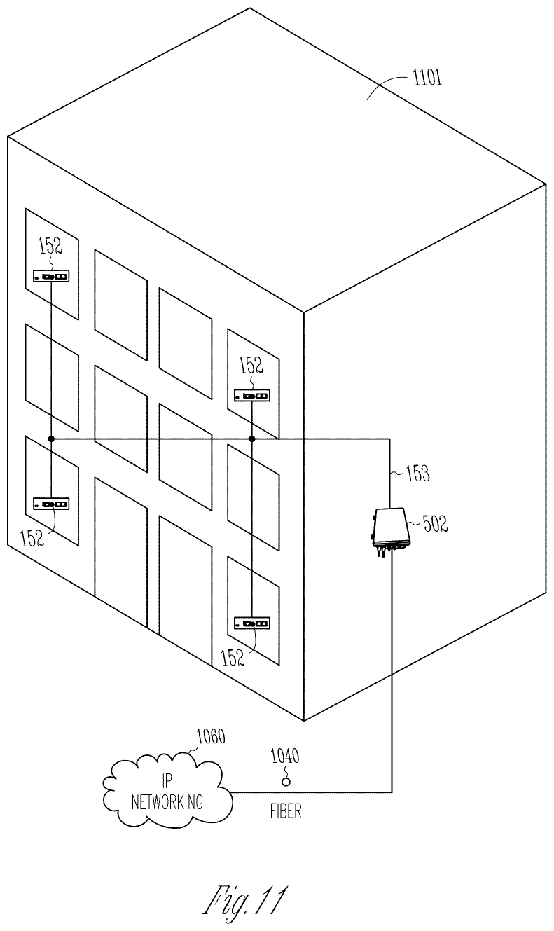

FIG. 11 illustrates a deployment of a digital communication vault and digital communication ports of the present subject matter according to one embodiment of the present subject matter. In the depicted embodiment, a service location 1101 has a plurality of digital communication ports 152 for internet service. The digital communication ports 152 are connected to a digital communication vault 502 that interfaces with a fiber optic cable 1040 to provide internet via an internet protocol (IP) network 1060. The digital communication vault 502 is connected to the digital communication ports 152 using conductors to provide RF modulation communications, in various embodiments. According to various embodiments, the digital communication vault 502 receives power via a reverse power feed (RPF) or a shared reverse power feed (SRPF) 153 using the twisted wire connection from one or more of the digital communication ports 152. In various embodiments, the digital communication vault 502 receives power via a reverse power feed (RPF) or a shared reverse power feed (SRPF) 153 using coaxial cable connections from one or more of the digital communication ports 152.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module”refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with the figures of this application are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Example Machine Architecture and Machine-readable Medium

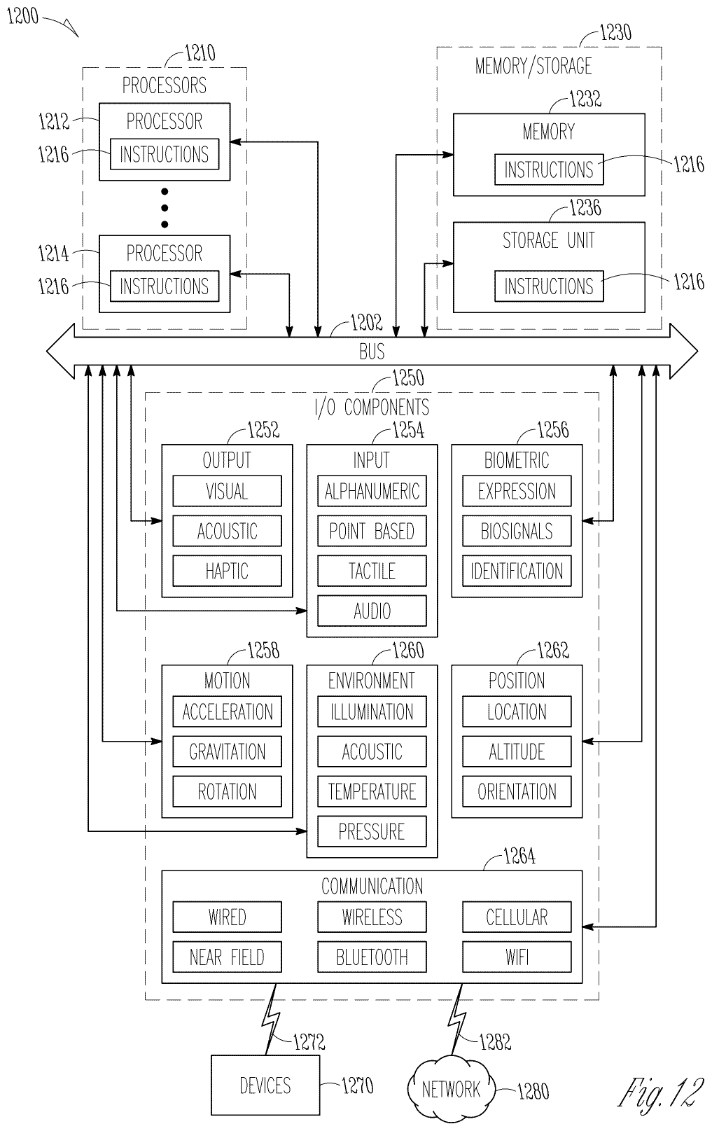

FIG. 12 is a block diagram illustrating components of a machine 2300, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein may be executed. For example, the instructions may cause the machine to execute the flow diagrams of FIGS. 8-10. Additionally, or alternatively, the instructions may implement one or more of the devices and/or components of the present subject matter. The instructions transform the general, non-programmed machine into a particular machine programmed to carry out the described and illustrated functions in the manner described. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a personal digital assistant (PDA), or any machine capable of executing the instructions 1216, sequentially or otherwise, that specify actions to be taken by machine 1200.

Further, while only a single machine 1200 is illustrated, the term “machine” shall also be taken to include a collection of machines 1200 that individually or jointly execute the instructions 1216 to perform any one or more of the methodologies discussed herein.

The machine 1200 may include processors 1210, memory/storage 1230, and I/O components 1250, which may be configured to communicate with each other such as via a bus 1202. In an example embodiment, the processors 1210 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1212 and processor 1214 that may execute instructions 1216. The term “processor” is intended to include multi-core processor that may comprise two or more independent processors (sometimes referred to as “cores”) that may execute instructions contemporaneously. Although FIG. 12 shows multiple processors, the machine 1200 may include a single processor with a single core, a single processor with multiple cores (e.g., a multi-core process), multiple processors with a single core, multiple processors with multiples cores, or any combination thereof.

The memory/storage 1230 may include a memory 1232, such as a main memory, or other memory storage, and a storage unit 1236, both accessible to the processors 1210 such as via the bus 1202. The storage unit 1236 and memory 1232 store the instructions 1216 embodying any one or more of the methodologies or functions described herein. The instructions 1216 may also reside, completely or partially, within the memory 1232, within the storage unit 1236, within at least one of the processors 1210 (e.g., within the processor's cache memory), or any suitable combination thereof, during execution thereof by the machine 1200. Accordingly, the memory 1232, the storage unit 1236, and the memory of processors 1210 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1216. The term “machine-readable medium” shall also be taken to include any medium, or combination of multiple media, that is capable of storing instructions (e.g., instructions 1216) for execution by a machine (e.g., machine 1200), such that the instructions, when executed by one or more processors of the machine 1200 (e.g., processors 1210), cause the machine 1200 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium”excludes signals per se.

The I/O components 1250 may include a wide variety of components to receive input, provide output, produce output, transmit information, exchange information, capture measurements, and so on. The specific I/O components 1250 that are included in a particular machine will depend on the type of machine. For example, portable machines such as mobile phones will likely include a touch input device or other such input mechanisms, while a headless server machine will likely not include such a touch input device. It will be appreciated that the I/O components 1250 may include many other components that are not shown in FIG. 12. The I/O components 1250 are grouped according to functionality merely for simplifying the following discussion and the grouping is in no way limiting. In various example embodiments, the I/O components 1250 may include output components 1252 and input components 1254. The output components 1252 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1254 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1250 may include biometric components 1256, motion components 1258, environmental components 1260, or position components 1262 among a wide array of other components. For example, the biometric components 1256 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1258 may include acceleration sensor components (e.g., accelerometer), gravitation sensor components, rotation sensor components (e.g., gyroscope), and so forth. The environmental components 1260 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1262 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1250 may include communication components 1264 operable to couple the machine 1200 to a network 1280 or devices 1270 via coupling 1282 and coupling 1272 respectively. For example, the communication components 1264 may include a network interface component or other suitable device to interface with the network 1280. In further examples, communication components 1264 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1270 may be another machine or any of a wide variety of peripheral devices (e.g., a peripheral device coupled via a Universal Serial Bus (USB)).

Moreover, the communication components 1264 may detect identifiers or include components operable to detect identifiers. For example, the communication components 1264 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF413, Ultra Code, UCC RSS-2D bar code, and other optical codes), or acoustic detection components (e.g., microphones to identify tagged audio signals). In addition, a variety of information may be derived via the communication components 1264, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1280 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1280 or a portion of the network 1280 may include a wireless or cellular network and the coupling 1282 may be a Code Division Multiple Access (CDMA) connection, a Global System for Mobile communications (GSM) connection, or other type of cellular or wireless coupling. In this example, the coupling 1282 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1216 may be transmitted or received over the network 1280 using a transmission medium via a network interface device (e.g., a network interface component included in the communication components 1264) and utilizing any one of a number of well-known transfer protocols (e.g., hypertext transfer protocol (HTTP)). Similarly, the instructions 1216 may be transmitted or received using a transmission medium via the coupling 1272 (e.g., a peer-to-peer coupling) to devices 1270. The term “transmission medium” shall be taken to include any intangible medium that is capable of storing, encoding, or carrying instructions 1216 for execution by the machine 1200, and includes digital or analog communications signals or other intangible medium to facilitate communication of such software.

### EXAMPLES

Example 1 is a digital system, including: a digital communication port, including: radio frequency (RF) modulation communications electronics for communications over multiple conductors; and electronics configured to receive power from a power source, to determine if the digital communication port is connected and to selectively supply power to another digital device to provide a shared power to the digital device.

Example 2 is the digital system of Example 1, wherein the digital communication port is a modem configured to detect connection to a distribution point unit (DPU).

Example 3 is the digital system of Example 2, wherein the DPU and the modem are configured to communicate using a G.hn standard.

Example 4 is the digital system of Example 2, wherein the DPU and the modem are configured to communicate using a G.fast standard.

Example 5 is the digital system of Example 2, wherein the DPU and the modem are configured to communicate via Ethernet.

Example 6 is the digital system of Example 2, wherein the multiple conductors include coaxial cable.

Example 7 is the digital system of Example 1, wherein the multiple conductors include coaxial cable.

Example 8 is the digital system of Example 2, wherein the multiple conductors include twisted wire.

Example 9 is the digital system of Example 1, wherein the multiple conductors include twisted wire.

Example 10 is the digital system of Example 1, wherein the radio frequency (RF) modulation communications electronics are configured to conduct communications including one or more of discrete multi-tone (DMT) modulation, orthogonal frequency division multiplexing (OFDM), coded orthogonal frequency-division multiplexing (CODFDM), ultra-wideband (UWB), pulse-position modulation, or orthogonal frequency-division multiple access (OFDMA).

Example 11 is a system, including: a distribution point unit (DPU); a first digital communication port; a second digital communication port; and each digital communication port connected to a splitter connected to the DPU, and configured to communicate using radio frequency (RF) modulation communication electronics over multiple conductors, wherein each digital communication port includes shared reverse power feed electronics configured with electronics to execute instructions to detect a connection to the DPU, and configured to determine whether to supply power to the DPU using at least two of the multiple conductors.

Example 12 is the system of Example 11, wherein the first and second digital communication ports include a plurality of modems.

Example 13 is the system of Example 12, wherein the DPU and the plurality of modems are configured to communicate using a G.hn standard.

Example 14 is the system of Example 12, wherein the DPU and the plurality of modems are configured to communicate using a G.fast standard.

Example 15 is the system of Example 12, wherein the DPU and the plurality of modems are configured to communicate via Ethernet.

Example 16 is the system of Example 12, wherein the multiple conductors include coaxial cable.

Example 17 is the system of Example 11, wherein the multiple conductors include coaxial cable.

Example 18 is the system of Example 12, wherein the multiple conductors include twisted wire.

Example 19 is the system of Example 11, wherein the multiple conductors include twisted wire.

Example 20 is the system of Example 11, wherein the radio frequency (RF) modulation communication electronics are configured to conduct communications including one or more of discrete multi-tone (DMT) modulation, orthogonal frequency division multiplexing (OFDM), coded orthogonal frequency-division multiplexing (CODFDM), ultra-wideband (UWB), pulse-position modulation, or orthogonal frequency-division multiple access (OFDMA).

Example 21 is a method, including: deploying a plurality of modems that can source power to a DPU over multiple conductors used for radio frequency (RF) modulation communications; and powering the DPU using the plurality of modems providing shared power over the multiple conductors.

Example 22 is the method of Example 21, wherein the DPU and the plurality of modems are configured to communicate using a G.hn standard.

Example 23 is the method of Example 21, wherein the DPU and the plurality of modems are configured to communicate using a G.fast standard.

Example 24 is the method of Example 21, wherein the DPU and the plurality of modems are configured to communicate via Ethernet.

Example 25 is the method of Example 21, wherein the multiple conductors include coaxial cable.

Example 26 is the method of Example 22, wherein the multiple conductors include coaxial cable.

Example 27 is the method of Example 23, wherein the multiple conductors include coaxial cable.

Example 28 is the method of Example 21, wherein the multiple conductors include twisted wires.

Example 29 is the method of Example 22, wherein the multiple conductors include twisted wires.

Example 30 is the method of Example 23, wherein the multiple conductors include twisted wires.

Example 31 is the method of Example 21, wherein the radio frequency (RF) modulation communications include one or more of discrete multi-tone (DMT) modulation, orthogonal frequency division multiplexing (OFDM), coded orthogonal frequency-division multiplexing (CODFDM), ultra-wideband (UWB), pulse-position modulation, or orthogonal frequency-division multiple access (OFDMA).

Example 32 a system to implement any of Examples 1-31.

Example 33 is a method to implement any of Examples 1-32.

### Design Considerations

The shared reverse power feed system of the present subject matter can address at least one or more of the following design considerations:
Powering DPUs in locations without readily available power sources: This system allows for the installation of DPUs on building exteriors or roofs where traditional power outlets may not be accessible.
Utilizing existing infrastructure: By leveraging the existing coaxial cable infrastructure in buildings, this method eliminates the need for additional wiring or power installations, reducing deployment costs and complexity.
Improved reliability: With multiple modems sharing the power load, the system becomes more resilient and/or redundant. If one modem is disconnected or fails, the others can continue to power the DPU, ensuring uninterrupted service.
Flexible power distribution: The system can adapt to varying numbers of connected modems, from a single modem up to 16 (for G.hn standard), allowing for scalable deployments in different building sizes and configurations.
Overcoming distance limitations: By allowing multiple modems to contribute power, this method can potentially overcome power loss issues in longer cable runs, ensuring sufficient power reaches the DPU even in larger buildings or complexes.
Enabling additional services: The ability to boost voltage back up to 56V allows for powering external devices like fixed wireless access radios, expanding the potential applications and services that can be offered.

By addressing these issues, the multiple modem powering method enables more flexible, reliable, and cost-effective deployments of DPUs in various scenarios, particularly in multi-dwelling units or buildings with existing connection infrastructure.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. The scope of the invention should be determined with reference to the appended claims, along with the full scope of equivalents to which such claims are entitled.

1. A digital system, comprising:
a digital communication port, including:
radio frequency (RF) modulation communications electronics for communications over multiple conductors; and
electronics configured to receive power from a power source, to determine if the digital communication port is connected and to selectively supply power to another digital device to provide a shared power to the digital device.

2. The digital system of claim 1, wherein the digital communication port is a modem configured to detect connection to a distribution point unit (DPU).

3. The digital system of claim 2, wherein the DPU and the modem are configured to communicate using a G.hn standard.

4. The digital system of claim 2, wherein the DPU and the modem are configured to communicate using a G.fast standard.

5. The digital system of claim 2, wherein the DPU and the modem are configured to communicate via Ethernet.

6. The digital system of claim 2, wherein the multiple conductors include coaxial cable.

7. The digital system of claim 1, wherein the multiple conductors include coaxial cable.

8. The digital system of claim 2, wherein the multiple conductors include twisted wire.

9. The digital system of claim 1, wherein the multiple conductors include twisted wire.

10. The digital system of claim 1, wherein the radio frequency (RF) modulation communications electronics are configured to conduct communications comprising one or more of discrete multi-tone (DMT) modulation, orthogonal frequency division multiplexing (OFDM), coded orthogonal frequency-division multiplexing (CODFDM), ultra-wideband (UWB), pulse-position modulation, or orthogonal frequency-division multiple access (OFDMA).

11. A system, comprising:
a distribution point unit (DPU);
a first digital communication port;
a second digital communication port; and
each digital communication port connected to a splitter connected to the DPU, and configured to communicate using radio frequency (RF) modulation communication electronics over multiple conductors,
wherein each digital communication port includes shared reverse power feed electronics configured with electronics to execute instructions to detect a connection to the DPU, and configured to determine whether to supply power to the DPU using at least two of the multiple conductors.

12. The system of claim 11, wherein the first and second digital communication ports include a plurality of modems.

13. The system of claim 12, wherein the DPU and the plurality of modems are configured to communicate using a G.hn standard.

14. The system of claim 12, wherein the DPU and the plurality of modems are configured to communicate using a G.fast standard.

15. The system of claim 12, wherein the DPU and the plurality of modems are configured to communicate via Ethernet.

16. The system of claim 12, wherein the multiple conductors include coaxial cable.

17. The system of claim 11, wherein the multiple conductors include coaxial cable.

18. The system of claim 12, wherein the multiple conductors include twisted wire.

19. The system of claim 11, wherein the multiple conductors include twisted wire.

20. The system of claim 11, wherein the radio frequency (RF) modulation communication electronics are configured to conduct communications comprising one or more of discrete multi-tone (DMT) modulation, orthogonal frequency division multiplexing (OFDM), coded orthogonal frequency-division multiplexing (CODFDM), ultra-wideband (UWB), pulse-position modulation, or orthogonal frequency-division multiple access (OFDMA).

21. A method, comprising:
deploying a plurality of modems that can source power to a DPU over multiple conductors used for radio frequency (RF) modulation communications; and
powering the DPU using the plurality of modems providing shared power over the multiple conductors.

22. The method of claim 21, wherein the DPU and the plurality of modems are configured to communicate using a G.hn standard.

23. The method of claim 21, wherein the DPU and the plurality of modems are configured to communicate using a G.fast standard.

24. The method of claim 21, wherein the DPU and the plurality of modems are configured to communicate via Ethernet.

25. The method of claim 21, wherein the multiple conductors include coaxial cable.

26. The method of claim 22, wherein the multiple conductors include coaxial cable.

27. The method of claim 23, wherein the multiple conductors include coaxial cable.

28. The method of claim 21, wherein the multiple conductors include twisted wires.

29. The method of claim 22, wherein the multiple conductors include twisted wires.

30. The method of claim 23, wherein the multiple conductors include twisted wires.

31. The method of claim 21, wherein the radio frequency (RF) modulation communications include one or more of discrete multi-tone (DMT) modulation, orthogonal frequency division multiplexing (OFDM), coded orthogonal frequency-division multiplexing (CODFDM), ultra-wideband (UWB), pulse-position modulation, or orthogonal frequency-division multiple access (OFDMA).
